(19) United States
(12) Patent Application Publication
(10) Pub. No.: US 2020/0025326 A1
(43) Pub. Date: Jan. 23, 2020

(54) NOVEL HOLDER

(71) Applicant: VISIONER INC., Anaheim, CA (US)

(72) Inventors: Huaide REN, Anaheim, CA (US); Ying ZHANG, Anaheim, CA (US); Yuan HUO, Anaheim, CA (US); Wentao WANG, Anaheim, CA (US)

(21) Appl. No.: 16/040,443

(22) Filed: Jul. 19, 2018

(51) Int. Cl. F16M 11/10; F16M 11/20; F16M 13/02

(52) U.S. Cl. CPC F16M 11/10; F16M 11/22; F16M 13/022; F16M 11/2021

(57) ABSTRACT

A holder includes a first fixation end, a second fixation end, a first bar member, a second bar member parallel to the first bar member, and an elastic support member. Two ends of each of the first and second bar members are hinged to the first fixation end and the second fixation end, respectively. A first end of the elastic support member is hinged to the first bar member and/or the second bar member, and a second end of the elastic support member is hinged to the second fixation end.

### TECHNICAL FIELD OF THE PRESENT DISCLOSURE

The present disclosure relates to the technical field of office equipment, and in particular to a novel holder.

### BACKGROUND OF THE PRESENT DISCLOSURE

Generally, sides of a parallelogram structure may need to bear axial tension and stress, and need to have a certain rigidity to bear the stress which bends and deforms the sides.

The parallelogram structure is widely applied, especially in lifting adjustment field. As shown in FIG. 1, a common structure is as follows: the supporting and the position adjustment of a main body H are realized on a base G by a parallelogram structure ACFD, a bar AC is fixed on the main body H and a bar DF is fixed on the base G. And there is no connecting bar BE in structures of existing products. In some products, an air spring is provided between A and K for the purpose of connection, and when the main body H is pressed down towards the base G, AK tends to decrease in length thus forming the supporting (there are limiting structures at top and bottom vertexes of AD or CF). When the angle of AKD is slightly adjusted (the distance between K and D is increased or decreased) so that the weight of the main body H is balanced with the supporting force of the air spring, the height of the main body H is constant; and when the main body H is pressed down or raised up to the desired height, the main body H will be suspended.

In such a structure, two connecting bars AD and CF are required to be made of rigid material with bending resistance property, and are generally of a steel tube or plate bending structure, so that this structure occupies much space, large in volume, high in material consumption, and difficult to satisfy the special requirements on some structures or shapes. For example, if a holder of a circular tubular structure is to be manufactured, all structures should be encapsulated within the circular tube, and the circular tube should be as small as possible in diameter and as round as possible in shape. In this case, if the conventional structure is used, the circular tube needs to form one of AD and CF, and a U-shaped (circular tube, square tube or steel bar) rigid structural member needs to be further provided within the tube. If external circular tubular structure is merely for the decorative purpose, it is more difficult to lay out the internal space. Since there is an air spring between A and K, the balance force for bearing the main body H can be adjusted by finely adjusting the distance between D and K, and a certain distance is required. The larger the distance is, the higher the adjustment capability is. Since the distances between AD and CF will change during rotation and the structure is large in size, in order to avoid the obstruction from the external circular tube, the diameter of the circular tube has to be increased. As a result, the appearances of the products will be influenced.

### SUMMARY OF THE PRESENT DISCLOSURE

The present disclosure is aimed at solving the above problems. An objective of the present disclosure is to provide a novel holder in order to solve any one of the above problems. Specifically, the present disclosure provides a novel holder having a compact and flexible structure.

To solve the technical problem, the present disclosure provides a novel holder, including a first fixation end, a second fixation end, a first bar member and a second bar member, the first bar member and the second bar member each have two ends respectively hinged to the first fixation end and the second fixation end and are parallel to each other, the novel holder being of a tubular structure and further including a main bar and an elastic support member, wherein:

the two ends of the main bar are hinged to the first fixation end and the second fixation end, respectively, the main bar is parallel to the first bar member, and fixation points at two ends of the main bar are located between fixation points of the first bar member and the second bar member; and

a first end of the elastic support member is hinged to the first bar member and/or the second bar member, while a second end of the elastic support member is hinged to the second fixation end.

The elastic support member includes a support bar and an elastic member, wherein:

two ends of the support bar are hinged to the first bar member and the second bar member, respectively, and the support bar is parallel to a connecting line between a fixation point of the first bar member at the first fixation end and a fixation point of the second bar member at the first fixation end; and

a first end of the elastic member is hinged to the support bar, and a second end of the elastic member is hinged to the second fixation end.

The main bar is made of rigid material.

The first bar member and/or the second bar member is made of flexible material.

The first bar member and/or the second bar member is of a bar structure or a sheet structure.

The elastic member is an air spring.

The novel holder is applied in a desktop monitor holding assembly.

In the novel holder of the present disclosure, by additionally providing a main bar to bear the bending resistance of the holder and by providing connecting bars to increase the degree of free adjustment of the holder, the range of choices for the materials to be used is expanded, the requirement on shape variability is satisfied, and the layout design in a more compact and tighter space can be realized.

Other characteristics, features and advantages of the present disclosure will become apparent by reading the following description of exemplary embodiments with reference to the drawings.

### BRIEF DESCRIPTION OF THE DRAWINGS

The drawings incorporated into the description and constituting a part of the description show the embodiments of the present disclosure, and are used for explaining the principle of the present disclosure in combination with the description. In these drawings, similar reference numerals represent similar elements. The drawings described hereinafter show some but not all of the embodiments of the present disclosure. A person of ordinary skill in the art can obtain other drawings according to these drawings without any creative effort.

FIG. 1 illustratively shows a diagram of the application principle of an existing parallelogram structure in a holder;

FIG. 2 illustratively shows a schematic diagram of an internal structure of a novel holder according to the present disclosure; and

FIG. 3 illustratively shows a sectional view of the novel holder according to the present disclosure.

### DETAILED DESCRIPTION OF THE EMBODIMENTS

To make the objectives, technical solutions and advantages of the embodiments of the present disclosure clearer, the technical solutions in the embodiments of the present disclosure will be described in conjunction with the drawings in the embodiments of the present disclosure. Apparently, the described embodiments are some but not all of the embodiments of the present disclosure. All other embodiments obtained by a person of ordinary skill in the art without any creative effort on the basis of the embodiments in the present disclosure shall fall into the scope of the present disclosure. It is to be noted that, the embodiments in the present application and the features in the embodiments can be combined at will so long as there is no conflict.

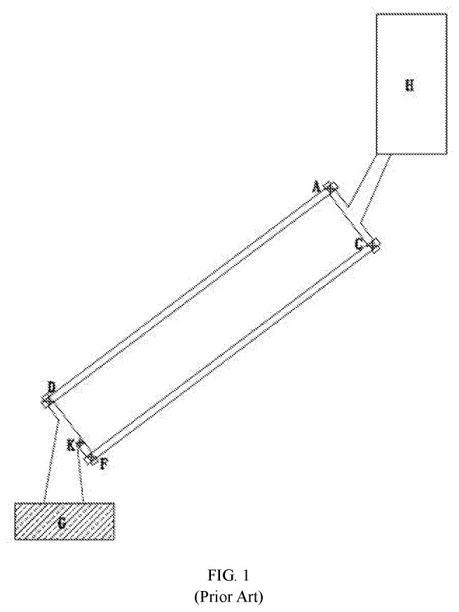

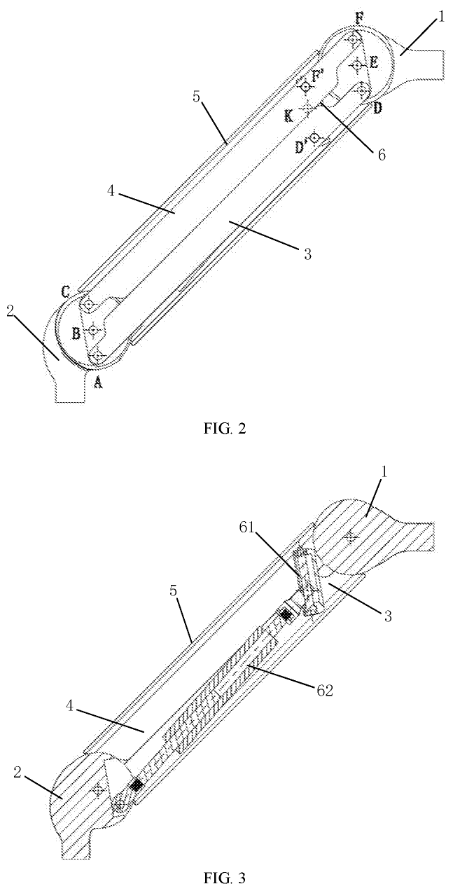

Referring to FIG. 1, in a holder of a conventional parallelogram structure, bar members AD and CF bear axial tension and stress, and hence the bar members AD and CF need to have a certain rigidity to bear the stress which bends and deforms them. Referring to FIG. 2, consistent with the present disclosure, a bar BE parallel to AD and CF is provided between AD and CF to bear and satisfy the bending resistance property of the parallelogram structure, without influencing the movement of the parallelogram structure. Since it is only required that AD and CF have certain tensile performance, the ranges of choices for the materials and structures of the AD and CF are expanded. Meanwhile, the bar BE is designed as a tubular structure which encircles the AD and CF, so the overall structure of the parallelogram structure can be effectively simplified, and the beautiful appearance is ensured.

It can be known from the principle of action and reaction, generally, in the case that AD and CF have the same rigidity, the overall structural rigidity of the parallelogram structure is the same as the rigidity of a structure having only one bar BE with the same rigidity. When one bar bears the tension, the other bar bears the stress, and the two bars will not bear a same force. When a rigid bar is added, and the additional rigid bar BE is applied a force, since the middle portion is supported, the stress borne by one bar of the two bars AD and CF will be converted into the tension borne by the other bar, so that the number of the rigid bars needed is decreased. In this case, the two bars AD and CF may be made of flexible material. In some embodiments, the two bars AD and CF may be made of rigid material or material with a lower rigidity.

The novel holder of the present disclosure will be described below in detail with reference to the drawings.

FIG. 2 shows a schematic diagram of an internal structure of the novel holder according to the present disclosure, and FIG. 3 shows a sectional view of the novel holder according to an embodiment of the present disclosure. As shown in FIG. 2 and FIG. 3, the novel holder includes a first fixation end 1, a second fixation end 2, a first bar member 3, and a second bar member 4. The first bar member 3 and the second bar member 4 each have two ends respectively hinged to the first fixation end 1 and the two fixation end 2 and are parallel to each other. This structure forms the framework of a four-rod mechanism of the novel holder. In the present disclosure, the novel holder is of a tubular structure and further includes a main bar 5 and an elastic support member 6, wherein the main bar 5 is of a tubular structure, and the elastic support member 6 is used for supporting and stabilizing the four-rod mechanism so that it is convenient for the adjustment of the supported height position of the novel holder.

Two ends of the main bar 5 are hinged to the first fixation end 1 and the second fixation end 2, respectively, and the main bar 5 is parallel to the first bar member 3. Fixation points of the main bar 5 at two ends are located between fixation points of the first bar member 3 and the second bar member 4. In this embodiment, the main bar 5 is of a circular tubular structure encircling the first bar member 3 and the second bar member 4.

A first end of the elastic support member 6 is hinged to the first bar member 3 and/or the second bar member 4, while a second end thereof is hinged to the second fixation end 2, so that it is convenient for ensuring the flexibility in use of the novel holder.

In one embodiment, as shown in FIG. 3, the elastic support member 6 includes a support bar 61 and an elastic member 62. Two ends of the support bar 61 are hinged to the first bar member 3 and the second bar member 4, respectively, and the support bar 61 is parallel to a connecting line between a fixation point of the first bar member 3 at the first fixation end 1 and a fixation point of the second bar member 4 at the first fixation end 1. That is, as shown in FIG. 2, F′D′ is parallel to FD. As such, the adjustment flexibility of the holder will not be influenced. The first end of the elastic member 62 is hinged to the support bar 61, while the second end thereof is hinged to the second fixation end 2. By providing the support bar 61, the length of the elastic member 62 can be effectively shortened. In the holder structure having the same length, the range of choices for the structures and strokes of the elastic member 62 is increased, the degree of freedom of the holder structure is expanded, and the adjustable range of lifting up and laying down the holder is extended. If no support bar 61 is provided, by merely increasing the length of the elastic member 62, the adjustable range of the holder will become shorter, and the bending resistance of the elastic member 62 will be required to be higher.

In the arrangement of the support bar 61 (represented by F′D′), the first bar member 3 (represented by AD) and the second bar member 4 (represented by CF) need to have certain rigidity. However, since the main bar 5 is provided as a main bearing bar for bearing the bending resistance and torsion resistance of the whole novel holder, it is only required that the first bar member 3 and the second bar member 4 have rigidity in a single direction and do not need to have torsion resistance, and the selectivities of the structures and materials of the first bar member 3 and the second bar member 4 are expanded. For example, a steel sheet may be selected as the first bar member 3 and/or the second bar member 4, without bending or performing other structural reinforcement changes.

In this embodiment, the main bar 5 is of a tubular structure, which may be a split structure for example formed by splicing left and right structures or upper and lower structures, and encircles the first bar member 3 and the second bar member 4 and is made of rigid material. Specifically, in shape, the main bar 5 may be of a circular tubular structure, or an oval tubular structure, or a square tubular structure or any other regular or irregular structure that can satisfy the requirements on the shape. The main bar 5 may be a variation of BE or F′D′ in the principle. By the novel holder of the present disclosure, the accident of pinching hands during the operation can be effectively prevented.

Since the main bar 5 bears the primary bending resistance and torsion resistance, the first bar member 3 and/or the second bar member 4 may be made of flexible material. In one embodiment, the first bar member 3 and/or the second bar member 4 may be selected as a bar structure or sheet structure.

In the embodiment shown in FIG. 2, the elastic member 62 is an air spring.

Finally, it is to be noted that the novel holder of the present disclosure can be applied in a desktop monitor holding assembly. Thus, the present disclosure also provides a desktop monitor holding assembly including the novel holder of the present disclosure. The desktop monitor holding assembly may further include a connection member connected to the novel holder and configured to further connect to a monitor.

The present disclosure mainly solves some problems (including problems in structure and appearance) that are difficult to be solved in applications of some parallelogram structures. Meanwhile, the ranges of choices for the structures and materials are expanded, the requirement on shape variability is satisfied, and the layout design in a more compact and tighter space can be realized. With the further increasement of knowledge, more and more application scenarios will be developed.

The contents described above can be implemented independently or jointly in various ways, and these transformations shall fall into the protection scope of the present disclosure.

It is to be noted that, as used herein, the relational terms such as “first” and “second” are merely used for distinguishing one entity or operation from another entity or operation, but do not necessarily require or imply any actual relationship or order between the entities or the operations. Moreover, the terms “comprise/comprising,” “contain/containing,” or any other variants thereof are non-exclusive, so that a process, method, object or device containing a series of elements contains not only these elements, but also other elements not listed clearly, or further contains inherent elements of the process, method, object or device. Without more restrictions, an element defined by the statement “comprises an/a . . . ” does not exclude other identical elements in the process, method, object or device including this element.

Finally, it is to be noted that the foregoing embodiments are merely used for describing the technical solutions of the present disclosure and not intended to limit the technical solutions of the present disclosure. Although the present disclosure has been described in detail with the foregoing embodiments, it should be understood by a person of ordinary skill in the art that modifications still can be made to the technical solutions described in the foregoing embodiments or equivalent replacements can be made to part of technical features, and these modifications or replacements will not make the essence of the corresponding technical solutions depart from the spirit and scope of the technical solutions in the embodiments of the present disclosure.

1. A holder comprising:
a first fixation end;
a second fixation end;
a first bar member including two ends hinged to the first fixation end and the second fixation end, respectively;
a second bar member parallel to the first bar member and including two ends hinged to the first fixation end and the second fixation end, respectively; and
an elastic support member, a first end of the elastic support member being hinged to the first bar member and the second bar member, and a second end of the elastic support member being hinged to the second fixation end, the elastic support member including:
a support bar, two ends of the support bar being hinged to the first bar member and the second bar member, respectively; and
an elastic member, a first end of the elastic member being hinged to the support bar at a position lying on a straight line connecting fixation points of the support bar that hinge the two ends of the support bar to the first bar member and the second bar member, respectively, and a second end of the elastic member being hinged to the second fixation end.

2. The holder according to claim 1, wherein:
the support bar is parallel to a connecting line between a fixation point of the first bar member at the first fixation end and a fixation point of the second bar member at the first fixation end.

3. The holder according to claim 1, wherein the elastic member includes an air spring.

4. The holder according to claim 1, further comprising:
a main bar parallel to the first bar member, two ends of the main bar being hinged to the first fixation end and the second fixation end, respectively, and each of the two ends of the main bar being hinged to one of the first fixation end and the second fixation end at a fixation point located between fixation points of the first bar member and the second bar member at which the first bar member and the second bar member are hinged to the one of the first fixation end and the second fixation end.

5. The holder according to claim 4, wherein the main bar is made of rigid material.

6. The holder according to claim 1, wherein the first bar member and/or the second bar member is made of flexible material.

7. The holder according to claim 1, wherein the first bar member and/or the second bar member is of a bar structure or a sheet structure.

8. The holder of claim 1, wherein the holder is of a tubular structure.

9. (canceled)

10. (canceled)

11. The holder according to claim 1, wherein the second end of the elastic member is hinged to the second fixation end at a same position as the first bar member hinged to the second fixation end.

12. The holder according to claim 4, wherein the main bar has a circular tubular structure encircling the first bar member and the second bar member.
